(19) United States
(12) Patent Application Publication
(10) Pub. No.: US 2011/0307169 A1
(43) Pub. Date: Dec. 15, 2011

(54) Information Processing Apparatus, Information Processing Method, Information Processing System, and Program

(76) Inventors: Kunitoshi Shimizu, Kanagawa (JP); Hiroshi Yamaguchi, Tokyo (JP); Tomohiko Sakamoto, Tokyo (JP); Mikita Yasuda, Kanagawa (JP); Yasu Nakano, Tokyo (JP)

(21) Appl. No.: 13/152,801

(22) Filed: Jun. 3, 2011

(30) Foreign Application Priority Data
Jun. 15, 2010 (JP) P2010-136306

(51) Int. Cl. G06K 9/00; G01C 21/34

(52) U.S. Cl. 701/201; 382/113

(57) ABSTRACT

There is provided an information processing apparatus including a map matching section configured to extract, based on a result obtained by measuring a position of a user, a candidate for a road along which the user is proceeding, and a selection section configured to select a road along which the user is proceeding from among candidates for the road, based on an analysis result obtained by recognizing a character written on a signpost included in a video in which a view in a travelling direction of the user is shot.

### BACKGROUND

The present disclosure relates to an information processing apparatus, an information processing method, an information processing system, and a program.

In recent years, services such as GPS (Global Positioning System) have been in widespread use, each of which uses a current position of a user acquired by a device for acquiring position information. In the past, such a service mainly provided a route from a current position of a user to a destination on a map, as a car navigation system mounted on a vehicle. Currently, however, more devices for acquiring position information are mounted on various portable devices such as a mobile phone, a portable game device, a PDA (Personal Data Assistance), a PC (Personal Computer), and a camera. The information to be provided is not limited to the route to the destination, and there are provided various pieces of information associated with position information.

In a device configured to provide information associated with position information, various techniques are used for providing precise position information. For example, there is used a map matching technique of specifying a route on a road network along which a user is travelling, based on information on an absolute position obtained by a GPS and information on relative position obtained by using a sensor or the like (for example, see JP 2009-74986A). In recent years, the accuracy of the position information has been enhanced owing to enhancement in the accuracy of the GPS, enhancement in map matching technology, and the like.

### SUMMARY

However, of the position information, information on the altitude is still not sufficiently accurate, and in the case where there were multiple number of roads such as an expressway and a general road, and one of them ran above the other, there was an issue that multiple number of candidates for a road along which the user was proceeding were extracted as a result of performing map matching, and it was difficult to specify the road along which the user was proceeding. Even when there is used technology for determining an altitude from pressure difference measured by using a barometer, it was also difficult to solve the issue.

In light of the foregoing, it is desirable to provide an information processing apparatus, an information processing method, an information processing system, and a program, which are novel and improved, and which are capable of selecting, in the case where multiple candidates for a road along which the user is proceeding are extracted based on position information, a road along which the user is proceeding from among the extracted candidates for the road.

According to an embodiment of the present disclosure, there is provided an information processing apparatus which includes a map matching section configured to extract, based on a result obtained by measuring a position of a user, a candidate for a road along which the user is proceeding, and a selection section configured to select a road along which the user is proceeding from among candidates for the road, based on an analysis result obtained by recognizing a character written on a signpost included in a video in which a view in a travelling direction of the user is shot.

According to such a configuration, the information processing apparatus is capable of selecting, in the case where there are multiple candidates for the road along which the user is proceeding as a result of performing map matching, one of the roads as the road along which the user is proceeding, based on a result obtained by analyzing the video in which the view in the travelling direction of the user is shot. Here, the information processing apparatus is a position recognition device having a function of recognizing a position of the information processing apparatus based on at least positioning information and analysis information, and for example, the information processing apparatus is a navigation device. Here, in the case of a navigation device mounted on a vehicle, the position of the user represents a position of the navigation device, and indicates a position of the vehicle.

The selection section may select the road along which the user is proceeding based on an appearance pattern of a signpost including a special character in the analysis result.

The selection section may select the road along which the user is proceeding based on presence or absence of appearance of the special character that is assumed to appear only on any one of the roads among the candidates for the road.

The candidates for the road may be a general road and an expressway, one of which runs above the other. The selection section may select one of the general road and the expressway as the road along which the user is proceeding.

The selection section may select the road along which the user is proceeding based on the analysis result, which is a result obtained by checking character information acquired from a storage device, which holds signpost information including position information of a signpost set up on the expressway and character information written on the signpost, against character information of the signpost included in the video.

The information processing apparatus may further include an updating section configured to update the signpost information included in the storage device based on the result obtained by checking the character information acquired from the storage device holding the signpost information against the character information of the signpost included in the video.

When the checking result indicates that a part of the character information acquired from the storage device holding the signpost information does not correspond with a part of the character information of the signpost included in the video, the updating section may update the non-corresponding part of the signpost information included in the storage device.

The information processing apparatus may further include a destination setting section configured to set a destination in accordance with input from the user, and a route guidance section configured to show a route to the destination using position information of the user based on the road selected by the selection section.

According to another embodiment of the present disclosure, there is provided an information processing method which includes a measurement step of measuring a position of a user, an extraction step of extracting a candidate for a road along which the user is proceeding based on the result of the position measurement, an analysis step of recognizing a character written on a signpost included in a video in which a view in a travelling direction of the user is shot, and a selection step of selecting a road along which the user is proceeding from among candidates for the road, based on the analysis result obtained in the analysis step.

According to another embodiment of the present disclosure, there is provided an information processing system which includes an imaging device configured to shoot a view in a travelling direction of a user, and an information processing apparatus which includes a map matching section configured to extract, based on a result obtained by measuring a position of the user, a candidate for a road along which the user is proceeding, and a selection section configured to select a road along which the user is proceeding from among candidates for the road, based on an analysis result obtained by recognizing a character written on a signpost included in a video shot by the imaging device.

According to another embodiment of the present disclosure, there is provided a program for causing a computer to function as an information processing apparatus which includes a map matching section configured to extract, based on a result obtained by measuring a position of a user, a candidate for a road along which the user is proceeding, and a selection section configured to select a road along which the user is proceeding from among candidates for the road, based on an analysis result obtained by recognizing a character written on a signpost included in a video in which a view in a travelling direction of the user is shot.

According to the embodiments of the present disclosure described above, it is possible, in the case where multiple candidates for the road along which the user is proceeding are extracted, to select the road along which the user is proceeding from among the extracted candidates for the road.

### BRIEF DESCRIPTION OF THE DRAWINGS

FIG. 1 is a configuration diagram of an information processing system according to a first embodiment of the present disclosure;

FIG. 2 is an external view of a navigation device according to the embodiment;

FIG. 3 is an explanatory diagram showing an example of a video acquired by an imaging device;

FIG. 4 is an explanatory diagram showing examples of signposts found on an expressway;

FIG. 5 is a flowchart showing operation of determining a position of a navigation device;

FIG. 6 is a configuration diagram of an information processing system according to a second embodiment of the present disclosure;

FIG. 7 is a table showing an example of signpost information;

FIG. 8 is an explanatory diagram illustrating analysis and selection processing performed in the embodiment;

FIG. 9 is an external view in the case where a navigation device represents a mobile phone; and

FIG. 10 is a configuration diagram of a mobile phone.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be given in the following order.

1. First embodiment (example of using appearance rule of character information)

2. Second embodiment (example of using result obtained by checking against signpost information)

3. Third embodiment (embodiment in case of mobile phone)

### 1. First Embodiment

[Configuration of Information Processing System]

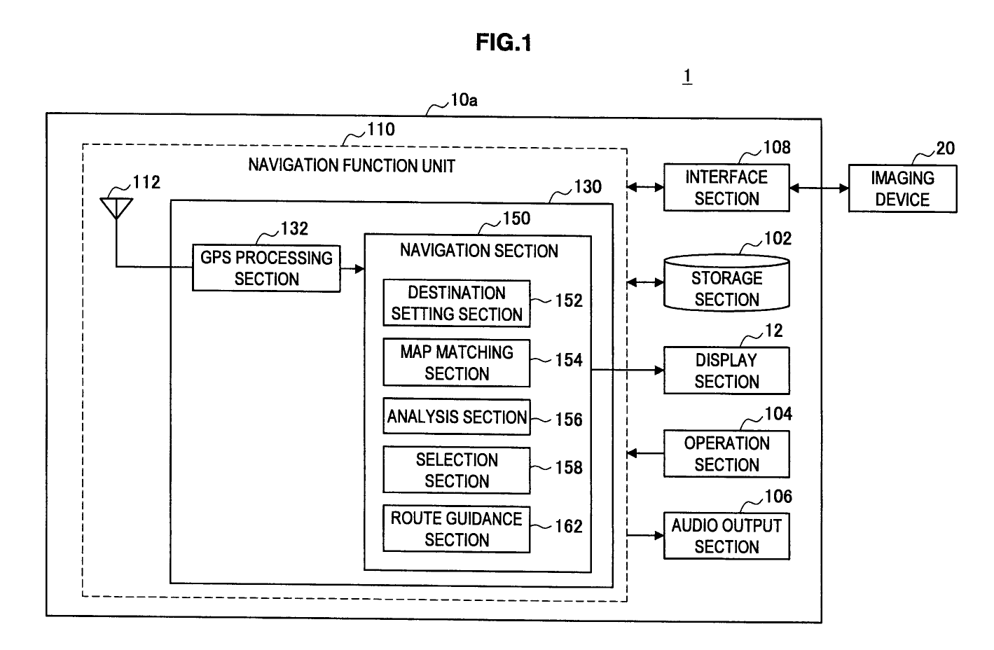

First, with reference to FIG. 1, a schematic configuration of an information processing system according to a first embodiment of the present disclosure will be described.

An information processing system 1 mainly includes an information processing apparatus 10 and an imaging device 20. The information processing apparatus 10 is a position recognition device having a function of recognizing a position of the information processing apparatus 10 based on at least positioning information and analysis information. Further, in the present embodiment, the information processing apparatus 10 is a navigation device which shows a route to a destination based on the recognized position information. Hereinafter, the information processing apparatus 10 is referred to as navigation device 10a.

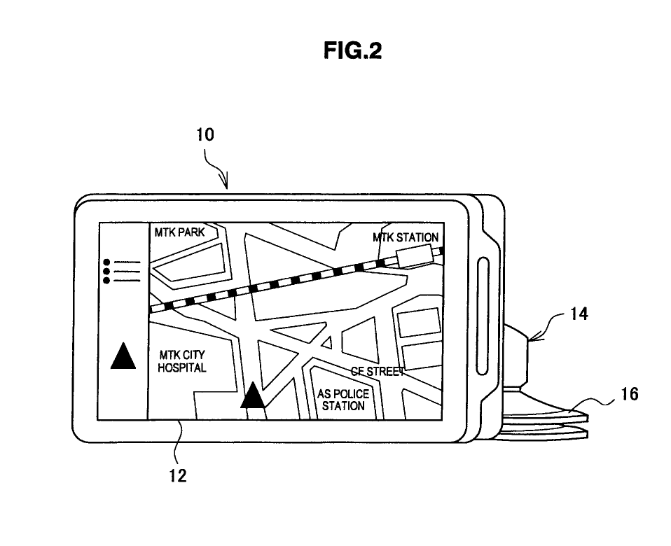

The navigation device 10a is, for example, a PND (Personal Navigation Device) having an appearance as shown in FIG. 2. FIG. 2 is an external view of a navigation device 10 according to the embodiment. The navigation device 10 is a portable navigation device which has functions of showing a route to a destination and providing a user with various pieces of information each associated with position information. The navigation device 10 has a display section 12, and is held by a cradle 14 which is attached to a dashboard of a vehicle via a suction cup 16.

The navigation device 10 has a function of acquiring a current position, and stores map data. Therefore, the navigation device 10 can display on the display section 12 the information of the current position in a superimposed manner on a map.

The imaging device 20 is a device for shooting a video, which is either a still image or a moving image, via a lens. The imaging device 20 and the navigation device 10 are connected with each other via a cable, and the imaging device 20 inputs the shot video to the navigation device 10. The imaging device 20 is installed at a position where a view in a travelling direction of a vehicle in which the navigation device 10 is installed can be shot.

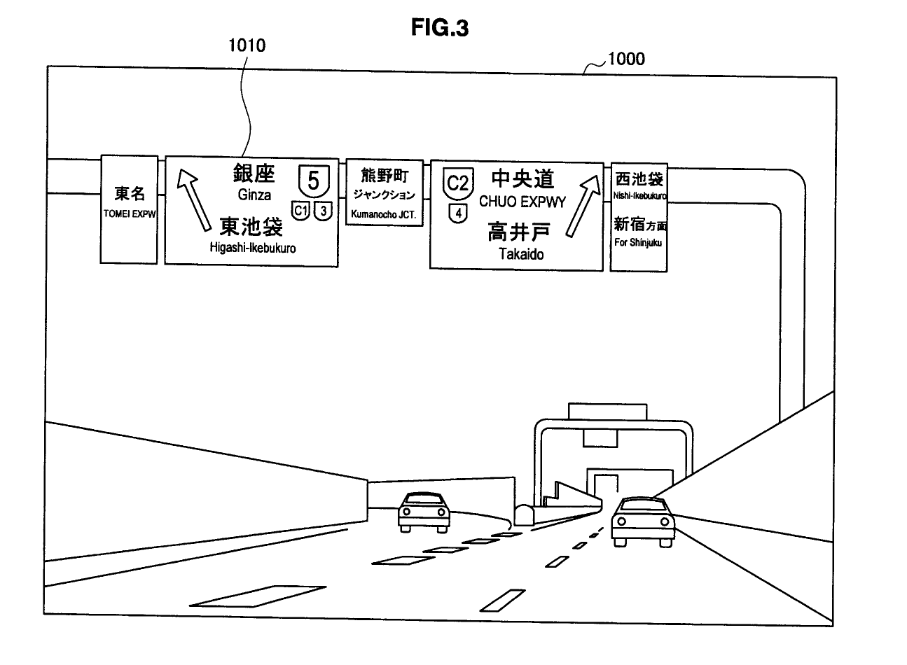

For example, the imaging device 20 shoots a video 1000 shown in FIG. 3. The video 1000 is analyzed by an analysis section included in the navigation device 10, and the navigation device 10a according to an embodiment of the present disclosure uses an analysis result which is a result obtained by recognizing characters included in the video 1000. Accordingly, in order to recognize the characters written on a signpost 1010 included in the video 1000, it is desirable to install the imaging device 20 at a position where the possibility of the signpost 1010 being shot is high.

The navigation device 10a mainly includes a display section 12, a storage section 102, an operation section 104, an audio output section 106, an interface section 108, and a navigation function unit 110.

The display section 12 is a display device which outputs a screen in which information indicating a current position is superimposed on map data. The display section 12 may be a display device such as an LCD (Liquid Crystal Display) and an organic EL (Electroluminescence) display.

The storage section 102 is a storage medium which stores a program for the navigation device 10a to operate, map data, and the like. Note that the storage section 102 may be, for example, a storage medium such as a non-volatile memory such as a Flash ROM (or Flash Memory), an EEPROM (Electrically Erasable Programmable Read-Only Memory), and an EPROM (Erasable Programmable ROM), a magnetic disk such as a hard disk and a disc-like magnetic disk, an optical disk such as a CD (Compact Disc), a DVD-R (Digital Versatile Disc Recordable), and a BD (Blu-Ray Disc (registered trademark)), and an MO (Magneto Optical) disk.

The operation section 104 accepts an operation instruction from the user, and outputs the operation contents to the navigation function unit 110. Examples of the operation instruction input by the user include setting a destination, enlarging/reducing the scale of a map, setting a vocal guidance, and setting a screen display.

Further, the operation section 104 may be a touch screen which is provided in an integrated manner with the display section 12. Alternatively, the operation section 104 may have a physical configuration such as a button, a switch, or a lever, which is provided separately from the display section 12. Further, the operation section 104 may be a signal reception section which detects a signal indicating an operation instruction input by the user transmitted from a remote controller.

The audio output section 106 is an output device which outputs audio data, and may be a speaker and the like. The audio output section 106 outputs navigation audio guidance, for example. The user listens to the audio guidance, which enables the user to find out the route to a destination even without watching the display section 12.

The interface section 108 is an interface for connecting the navigation device 10a with an external device. In the present embodiment, the interface section 108 is an interface including a connecter for connecting the navigation device 10a with the imaging device 20 via a cable. In the case where the imaging device 20 has a radio communication function, the interface section 108 may be a communication interface for connecting the navigation device 10a with the imaging device 20 via a radio link.

The navigation function unit 110 is a configuration for realizing a function of navigation, and mainly includes a GPS antenna 112 and a control section 130. The control section 130 includes a GPS processing section 132 and a navigation section 150. The navigation section 150 mainly has functions of a destination setting section 152, a map matching section 154, an analysis section 156, a selection section 158, and a route guidance section 162.

Further, the GPS antenna 112 and the GPS processing section 132 has a function as a positioning section using a GPS. The GPS antenna 112 is capable of receiving GPS signals from multiple GPS satellites, and inputs the received GPS signals to the GPS processing section 132. Note that the GPS signals received here include orbital data indicating orbits of the GPS satellites and information such as transmission time of the signals.

The GPS processing section 132 calculates position information indicating the current position of the navigation device 10a based on the multiple GPS signals input from the GPS antenna 112, and supplies the navigation section 150 with the calculated position information. Specifically, the GPS processing section 132 calculates a position of each of the GPS satellites from the orbital data obtained by demodulating each of the multiple GPS signals, and calculates a distance between each of the GPS satellites and the navigation device 10a from a difference between a transmission time and a reception time of the GPS signal. Then, based on the calculated positions of the respective GPS satellites and the distances from the respective GPS satellites to the navigation device 10a, a current three-dimensional position is calculated.

The navigation section 150 has a function of showing a route to a destination set by a user based on the positioning result obtained by the positioning section. Specifically, the destination setting section 152 sets a destination, which is a location that the user finally wants to arrive at, from operation information input by the user using the operation section 104, for example. The destination setting section 152 generates, for example, a screen for searching for the destination based on addresses, names, telephone numbers, or genres, or a screen for selecting the destination from the registration points that are registered by the user beforehand, and causes the display section 12 to display the screen. Then, the destination setting section 152 acquires the operation information performed to the screen display by the user using the operation section 104, and sets the destination.

The map matching section 154 acquires a position of the user on a map based on positioning information acquired by the positioning section. Specifically, the map matching section 154 specifies a route on a road network along which the user is travelling based on a history of the positioning information acquired by the positioning section. That is, the map matching section 154 extracts a candidate for the road along which the user is proceeding based on a result obtained by measuring the position of the user. With such a configuration, the position of the user is corrected.

In the case where, based on the positioning information, there are multiple candidates for the position of the user, the map matching section 154 causes the imaging device 20 to acquire a video and also causes the analysis section 156 to execute the analysis of the acquired video. As an example of the case where there are multiple candidates for the position of the user, there is given a case where there are a general road and an expressway, and one of them runs above the other. As described above, since the information on altitude is not is not sufficiently accurate, the navigation device 10a of the past is not good at distinguishing which one of the general road and the expressway, one of which runs above the other, the user is driving along. Accordingly, the navigation device 10a according to the present embodiment has functions as the analysis section 156 and the selection section 158 described below.

The analysis section 156 has a function of analyzing the video acquired by the imaging device 20. For example, the analysis section 156 recognizes a signpost included in the video, and outputs a result obtained by analyzing the signpost. For example, the analysis section 156 acquires information on color of the recognized signpost as the analysis result. Further, the analysis section 156 acquires character information included in the signpost as the analysis result based on character recognition. Moreover, the analysis section 156 may acquire not only the character information included in the signpost, but also character information that can be recognized from the video as the analysis result.

Among the candidates for the road along which the user is proceeding that are extracted by the map matching section 154, the selection section 158 selects a road along which the user is proceeding based on the analysis result obtained by the analysis section 156. The selection section 158 selects the road based on an appearance pattern of a signpost including special characters in the analysis result. For example, in the present embodiment, the selection section 158 selects a road based on a rule of the appearance pattern of a signpost. As the rule of the appearance pattern of a signpost, there can be exemplified presence or absence of appearance of special characters that are assumed to appear only on an expressway.

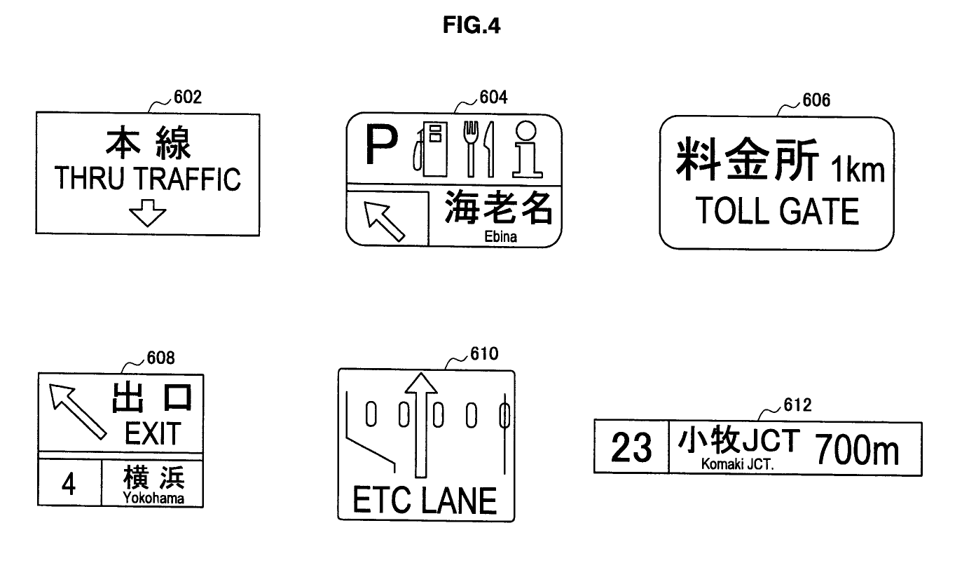

The selection section 158 selects, from among the general road and the expressway which are the candidates for the road along which the user is proceeding, the one that the user is actually proceeding based on the presence or absence of appearance of special characters that are assumed to appear only on an expressway, for example. FIG. 4 shows examples of signposts set up on an expressway. FIG. 4 is an explanatory diagram showing examples of signposts found on an expressway.

A signpost 602 represents, among traffic lanes along the expressway, a signpost showing a through line. Further, a signpost 604 represents a signpost for notifying a driver that there is a parking area. A signpost 606 is a signpost showing distance to a tollgate. A signpost 608 represents a signpost for notifying the driver that there is an exit. A signpost 610 represents a signpost for notifying the driver of, among lanes each leading to a tollgate, a lane that leads to an ETC (Electronic Toll Collection System)-usable tollgate. A signpost 612 represents a signpost for notifying the driver of a name of a junction and distance to the junction.

Those signposts are basically only used in the expressway. Consequently, the selection section 158 stores in advance special characters that are assumed to appear only on the expressway, and may determine that the road along which the user is proceeding is the expressway when finding those special characters in the analysis result. Examples of the special characters include “TOLL GATE”, “THRU TRAFFIC”, “ETC LANE”, and “JCT (or JUNCTION)”. In addition, the signpost set up on the expressway has a feature that white characters are written on a green background. On the other hand, in many of the signposts set up on the general road, white characters are written on a blue background. Consequently, the selection section 158 may select the road along which the user is proceeding by taking into consideration the information on colors.

Further, the selection section 158 may select the road along which the user is proceeding after recognizing special characters once, or may continue the selection processing until recognizing the special characters multiple times. When the recognition of the special characters is performed only once, there may be considered a case where similar character information is accidentally caught while driving along the general road, but on the other hand, when the selection processing is continued until the special characters are recognized multiple times, the accuracy of the selection can be enhanced.

Further, in the case where the special characters are not recognized for a predetermined time period, the selection section 158 may select the general road as the road along which the user is proceeding. In this case, in order to enhance the accuracy, it is desirable to continue the analysis and selection processing even after performing the selection once.

The route guidance section 162 has a function of causing the display section 12 to display a map on which information of a position of the user extracted by the map matching section 154 or information of a position of the user selected by the selection section 158 is superimposed as a current position, and a function of searching for a route to a destination and showing the route to the destination. For example, in the case where the destination is set by the destination setting section 152, the route guidance section 162 shows the route to the destination by a display, audio, and the like. Here, there can be considered various methods of showing the route to the destination. For example, in the case where the destination is included in the map displayed on the display section 12, the route guidance section 162 indicates a position of the destination by showing an icon or the like indicating the destination at the position. Alternatively, at a point from which the road branches off, the route guidance section 162 causes the display section 12 to display an arrow superimposed on the map, which indicates the direction of the destination.

[Operation]

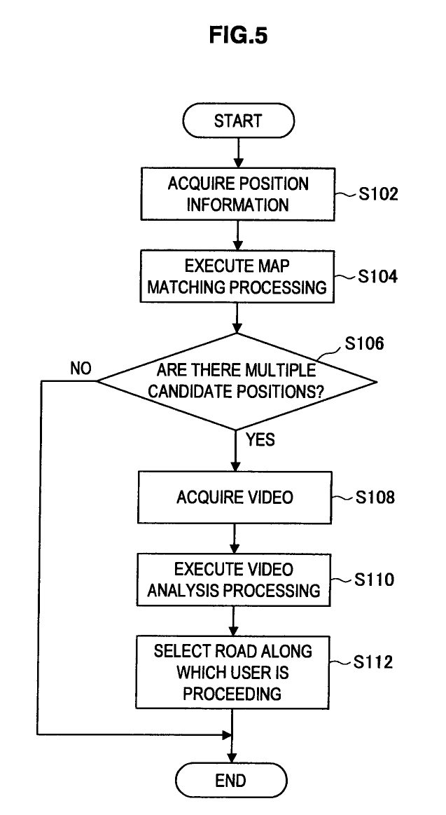

Next, with reference to FIG. 5, operation of determining a position performed by a navigation device according to the first embodiment of the present disclosure will be described. FIG. 5 is a flowchart showing operation of determining a position of a navigation device according to an embodiment of the present disclosure.

First, the map matching section 154 of the navigation device 10a acquires absolute position information acquired by the measurement of positions from the GPS processing section 132 (S102). Then, based on the acquired absolute position information, the map matching section 154 executes map matching processing (S104). That is, the map matching section 154 extracts, from among the acquired pieces of absolute position information, a candidate for a road on a road network along which the user is proceeding.

After that, it is determined whether or not there are multiple candidate positions for the road extracted by the map matching section 154 (S106). In the case where the number of the candidates for the road is not multiple in Step S106, that is, in the case where there is one candidate for the road, the road along which the user is proceeding is specified to be the extracted road, and the processing is completed.

On the other hand, in the case where it is determined in Step S106 that the number of the candidates for the road is multiple, the analysis section 156 acquires a video from the imaging device 20 (S108). Then, the analysis section 156 executes processing of analyzing the acquired video (S110). The processing of acquiring the video of Step S108 and the processing of analyzing the acquired video of Step S110 are continuously performed until the road along which the user is driving is specified.

After that, based on the analysis result obtained by the analysis section 156, the selection section 158 selects the road along which the user is proceeding from among the candidates for the road extracted by the map matching section 154 (S112). Here, the selection method performed by the selection section 158 is as described above.

[Examples of Effects]

As described above, in the case where there are multiple candidates for the road along which the user is proceeding as a result of the map matching processing, the information processing system 1 according to the first embodiment of the present disclosure can select any one of the roads based on the result obtained by analyzing a video shot by an imaging device. For example, in the case where there are a general road and an expressway, and one of them runs above the other, the information processing system 1 can select which of the general road and the expressway the user is driving along. In particular, in analyzing the video, the road along which the user is proceeding is selected based on an appearance pattern of special characters by using the result of character recognition. When the determination is performed based on the information on special characters that are assumed to appear only in a signpost on the expressway, the selection section 158 can determine whether the road along which the user is driving is the expressway or the general road depending on the presence or absence of appearance of the special characters.

### 2. Second Embodiment

[Configuration of Information Processing System]

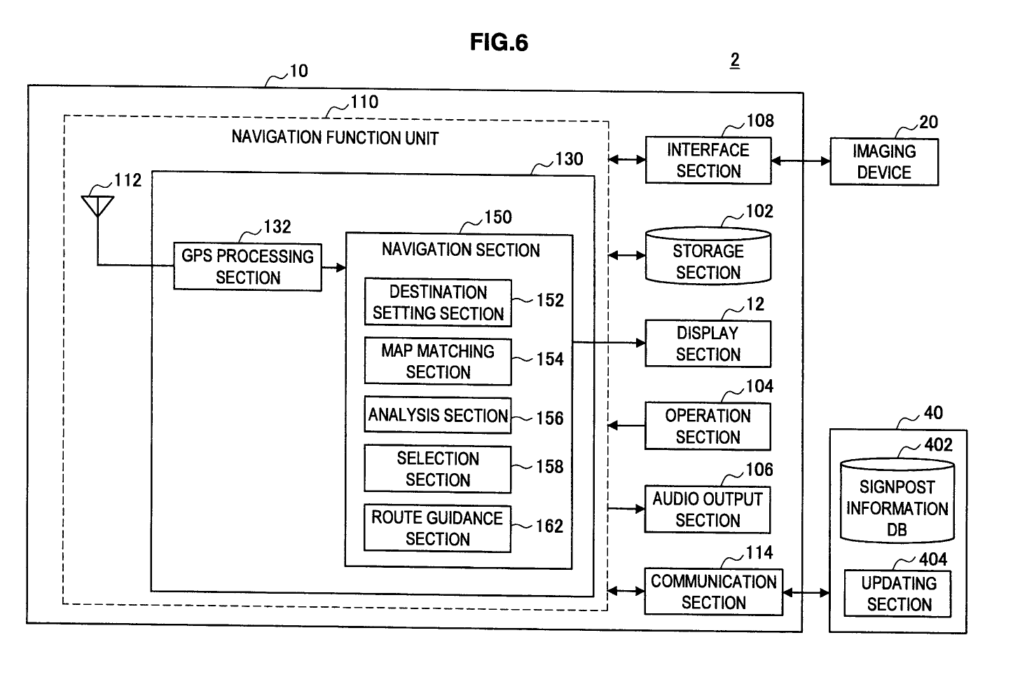

Next, a schematic configuration of an information processing system according to a second embodiment of the present disclosure will be described with reference to FIG. 6. FIG. 6 is a configuration diagram of the information processing system according to the second embodiment. Note that, in the description below, the description on a configuration that is the same as the configuration of the information processing system 1 according to the first embodiment will be omitted, and the description will be made mainly on the differences.

The information processing system 2 mainly includes a navigation device 10b, an imaging device 20, and a signpost information providing server 40. That is, the information processing system 2 includes, in addition to the configuration of the information processing system 1 according to the first embodiment, the signpost information providing server 40. The navigation device 10b selects a road along which the user is proceeding based on a result obtained by checking information of a signpost set up on any one of the candidates for the road against information of a signpost in a video acquired by the imaging device 20. In order to be used for the matching check, the signpost information providing server 40 includes a signpost information DB (database) 402 for holding information on a signpost set up on the expressway (hereinafter, referred to as signpost information).

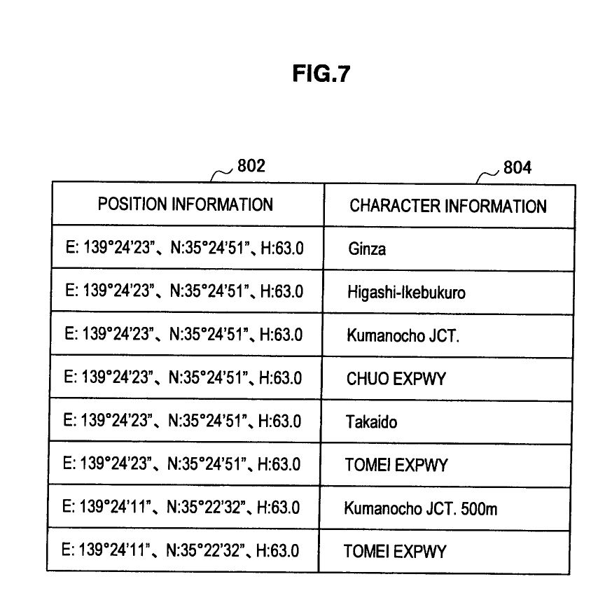

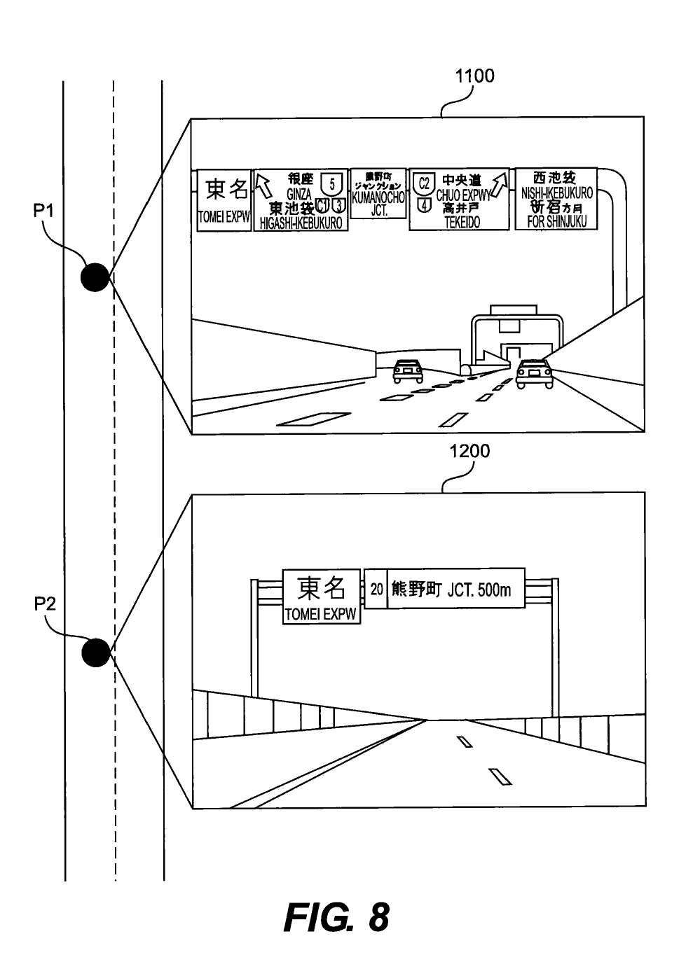

The signpost information database 402 includes, as shown in FIG. 7, position information 802 and character information 804 of signposts, for example. The position information 802 includes, for example, values of the east longitude, the north latitude, and the altitude. The character information 804 includes character information included in a signpost which is set up at a position indicated by the position information 802. The examples of the signpost information shown in FIG. 7 are pieces of information of signposts which are each set up at either a point P1 or a point P2 shown in FIG. 8.

As shown in FIG. 8, on an expressway, a video 1200 is acquired at the point P2, and a video 1100 is acquired at the point P1. The character information included in the signpost that can be recognized from the video acquired here should be the same when acquired at the same position again, as long as there are not performed the setting up another signpost and the detachment of the signpost. Consequently, the signpost information database 402 holds signpost information and provides the navigation device 10b with the signpost information.

The navigation device 10b mainly includes a display section 12, a storage section 102, an operation section 104, an audio output section 106, an interface section 108, a communication section 114, and a navigation function unit 110. That is, when the navigation device 10b is compared with the navigation device 10a according to the first embodiment, the navigation device 10b differs from the navigation device 10a in that it further includes a configuration of the communication section 114. Further, in comparison with the navigation device 10a, an analysis result output from the analysis section 156 and a criterion in selecting a road along which the user is driving by the selection section 158 are different.

The communication section 114 is a communication interface for being connected with an external device. The communication section 114 connects with the signpost information providing server 40, transmits a data acquisition request message to the signpost information database 402, and acquires desired information on a signpost from the signpost information providing server 40.

The analysis section 156 has a function of analyzing a video in which a view in a travelling direction of the user acquired by the imaging device 20 is shot. The analysis section 156 outputs an analysis result obtained by character recognition of a signpost. Specifically, the analysis section 156 recognizes the characters written on the signpost included in the video, and outputs, as the analysis result, a result obtained by checking character information of the signpost extracted from the video against character information included in signpost information acquired from the signpost information providing server 40.

The selection section 158 selects the road along which the user is proceeding from among candidates for the road extracted by a matching section based on the checking result obtained by the analysis section 156. Specifically, in the case where the signpost information database 402 has position information and character information of a signpost set up on the expressway, when the checking result indicates that the character information of the signpost acquired from the video corresponds to the character information included in the signpost information database 402, the selection section 158 selects the expressway as the road along which the user is proceeding.

In the embodiment described above, although the signpost information database 402 includes information on signposts set up on the expressway, the signpost information database 402 may include both the signpost information of the expressway and the signpost information of the general road. In this case, the analysis section 156 outputs, as the analysis results, results obtained by the checking with the signpost information of the expressway and the signpost information of the general road. Alternatively, in the case where there are three or more candidates for the roads extracted by the map matching section 154, pieces of signpost information corresponding to the three or more candidates for the roads, respectively, may be held by the signpost information database 402.

According to such a configuration, the road along which the user is proceeding is selected based on the result obtained by the checking with the preliminarily held signpost information. In the first embodiment, the road along which the user is proceeding is selected based on the information on the signpost which is “assumed” to appear only on one of the expressway and the general road. In the present embodiment, however, the road along which the user is proceeding is selected based on one of the signpost information of the expressway and the signpost information of the general road, which has higher probability of being present at each road. Therefore, further enhancement in the accuracy of selection can be expected.

However, it can be assumed that the signpost information may be changed. In this case, the signpost information providing server 40 includes a configuration of an updating section 404. The updating section 404 collects and analyzes the analysis result of the analysis section 156 of each navigation device 10. Then, as a result of the analysis, in the case where results of signpost information extracted from a certain road for a predetermined number of times corresponds with each other, and the results differs from the content of the database, the updating section 404 determines that the extracted signpost information to be correct information, and updates the signpost information included in the database. With such a configuration, there can be realized an automatic database updating system which does not require special investigation and maintenance performed by human workers and is capable of updating the signpost information with new information.

### 3. Third Embodiment (Mobile Phone)

In the above, the case where the PND is used as the navigation device has been described as the first embodiment and the second embodiment, but the navigation device is not limited to such an example. For example, a mobile phone 30, which will be described below as a third embodiment, may be used as the navigation device.

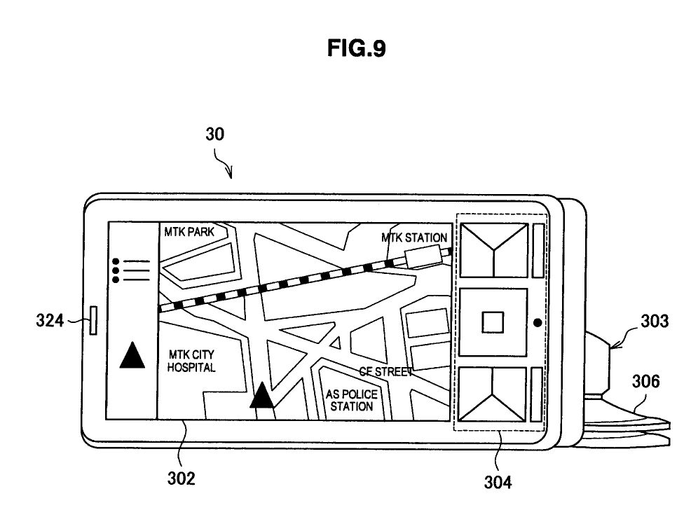

FIG. 9 is an external view of the mobile phone 30 according to the third embodiment. As shown in FIG. 9, the mobile phone 30 according to the third embodiment includes a display section 302, an operation section 304, and a speaker 324. Further, in the same manner as the PND according to the first embodiment and the second embodiment, the mobile phone 30 may be attached to a vehicle using a suction cup 306 via a cradle 303.

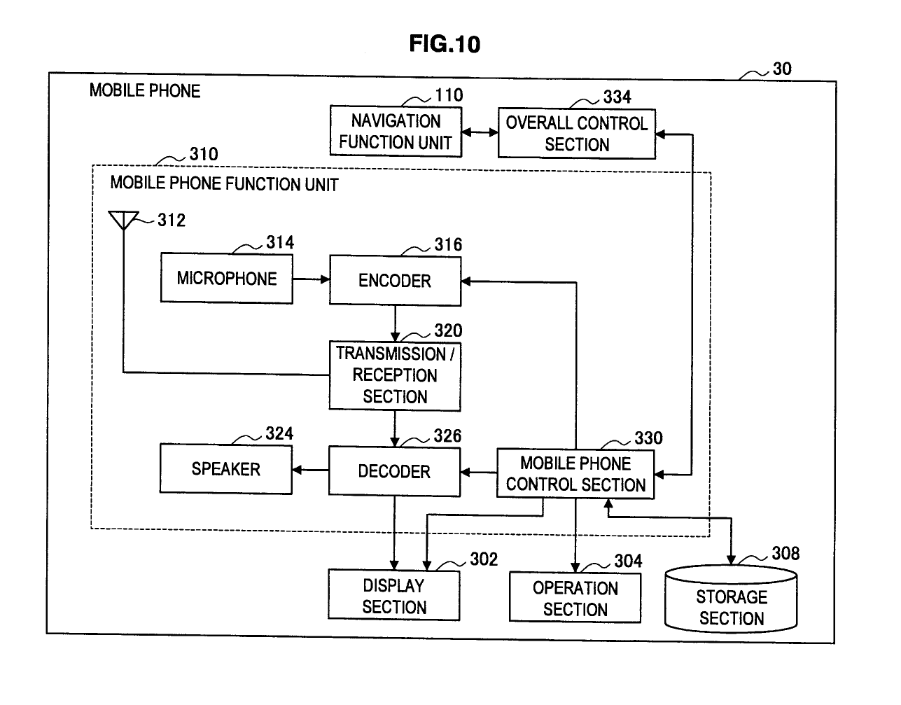

FIG. 10 is a block diagram showing a functional configuration of the mobile phone 30 according to the third embodiment. As shown in FIG. 10, the mobile phone 30 according to the third embodiment includes a navigation function unit 110, the display section 302, the operation section 304, a storage section 308, a mobile phone function unit 310, and an overall control section 334.

The mobile phone function unit 310 is connected to the display section 302, the operation section 304, and the storage section 308. In fact, although it is simplified in the drawing of FIG. 10, the display section 302, the operation section 304, and the storage section 308 are each connected to the navigation function unit 110. Note that, since the detailed configuration of the navigation function unit 110 has been specifically described in the first embodiment by using FIG. 1, the description thereof will be omitted here.

The mobile phone function unit 310 has a configuration for realizing a communication function and an e-mail function, and includes a communication antenna 312, a microphone 314, an encoder 316, a transmission/reception section 320, the speaker 324, a decoder 326, and a mobile phone control section 330.

The microphone 314 collects sound and outputs the sound as an audio signal. The encoder 316 performs digital conversion and encoding of the audio signal input from the microphone 314 in accordance with the control of the mobile phone control section 330, and outputs audio data to the transmission/reception section 320.

The transmission/reception section 320 modulates the audio data input from the encoder 316 in accordance with a predetermined system, and transmits the modulated audio data to a base station of the mobile phone 30 from the communication antenna 312 via radio waves. Further, the transmission/reception section 320 demodulates a radio signal received by the communication antenna 312 and acquires audio data, and outputs the audio data to the decoder 326.

The decoder 326 performs decoding and analog conversion of the audio data input from the transmission/reception section 320 in accordance with the control of the mobile phone control section 330, and outputs an audio signal to the speaker 324. The speaker 324 outputs the audio based on the audio signal supplied from the decoder 326.

Further, in the case of receiving an e-mail, the mobile phone control section 330 supplies the decoder 326 with received data from the transmission/reception section 320, and causes the decoder 326 to decode the received data. Then, the mobile phone control section 330 outputs e-mail data obtained by the decoding to the display section 302 and causes the display section 302 to display the e-mail data, and also records the e-mail data in the storage section 308.

Further, in the case of transmitting an e-mail, the mobile phone control section 330 causes the encoder 316 to encode the e-mail data which is input via the operation section 304, and transmits the encoded e-mail data via radio waves through the transmission/reception section 320 and the communication antenna 312.

The overall control section 334 controls the mobile phone function unit 310 and the navigation function unit 110. For example, in the case of receiving a phone call while the navigation function unit 110 is executing a navigation function, the overall control section 334 may temporarily switch its function from the navigation to a verbal communication carried out by the mobile phone function unit 310, and, when the call ends, may cause the navigation function unit 110 to restart the navigation function.

In the case where a navigation device represents a mobile phone, the configuration of the communication section 114 of the second embodiment may be realized by the communication antenna 312 and the transmission/reception section 320.

It should be understood by those skilled in the art that various modifications, combinations, sub-combinations and alterations may occur depending on design requirements and other factors insofar as they are within the scope of the appended claims or the equivalents thereof.

For example, in the embodiments described above, although the imaging device is provided as a separate casing from the navigation device, the present disclosure is not limited to such an example. For example, the imaging device may be formed in an integrated manner with the navigation device. In this case, it is desirable that a lens of the imaging device formed as a part of the navigation device is installed at a position where a view in a travelling direction of a vehicle can be shot.

Further, in the embodiments described above, although the imaging device and the navigation device are connected with each other via a cable, the present disclosure is not limited to such an example. The imaging device and the navigation device may have a radio communication section, and a shot video may be transmitted/received therebetween via a radio communication path.

Further, in the embodiments described above, although the processing of analyzing the video is performed only in the case where there are multiple candidates for the road along which the user is proceeding based on map matching, the present disclosure is not limited to such an example. For example, the analysis may be continuously executed, and, only in the case where there are multiple candidates for the road, a selection section may acquire the analysis result.

Further, in the embodiments described above, although the navigation device includes an analysis section, the present disclosure is not limited to such an example. For example, a video imaged by the imaging device may be transmitted to an analysis server on the Internet, and the navigation device may acquire the analysis result obtained by the analysis server and may select the road along which the user is proceeding.

Further, in the embodiments described above, the navigation device has the positioning function using the GPS, and the navigation device may also have the function of an autonomous navigation using a sensor or the like. In this case, a map matching section performs map matching processing based on at least any one of positioning information obtained by using the GPS and positioning information obtained by using the autonomous navigation, and extracts a candidate for the road along which the user is driving.

Further, in the embodiments described above, although the navigation device selects the road based on rules about a signpost on the expressway, the present disclosure is not limited thereto. For example, the road may be selected based on an appearance pattern of a recognized object which is assumed to appear in the video shot on the general road. For example, a traffic light is generally not present on the expressway, and it is assumed to appear only on the general road. Further, an appearance pattern of a recognized object which is assumed to appear on the expressway and an appearance pattern of a recognized object which is assumed to appear on the general road may be used in combination.

Further, in the second embodiment described above, although signpost information is acquired from the signpost information database included in the server on the Internet on a case-by-case basis, the present disclosure is not limited to such an example. For example, the navigation device may include the signpost information database. In this case, the navigation device may hold signpost information collected from throughout Japan, or may acquire signpost information in the vicinity of a current point at regular intervals based on positioning information.

Further, in the second embodiment described above, although the signpost information database includes the position information and the character information of a signpost, the present disclosure is not limited to such an example. For example, the signpost information database may include image information of a signpost, instead of the character information of the signpost or in addition to the character information of the signpost.

Further, in the second embodiment described above, although the updating section is included in the signpost information providing server, the present disclosure is not limited to such an example. For example, in the case where signpost information is included in the storage device provided inside the navigation device, the navigation device may have a function of the updating section.

Note that in the present specification, the steps written in the flowchart may of course be processed in chronological order in accordance with the stated order, but may not necessarily be processed in the chronological order, and may be processed individually or in a parallel manner. It is needless to say that, in the case of the steps are processed in the chronological order, the order of the steps may be changed appropriately according to circumstances.

The present disclosure contains subject matter related to that disclosed in Japanese Priority Patent Application JP 2010-136306 filed in the Japan Patent Office on Jun. 15, 2010, the entire content of which is hereby incorporated by reference.

What is claimed is:

1. An information processing apparatus comprising:
a map matching section configured to extract, based on a result obtained by measuring a position of a user, a candidate for a road along which the user is proceeding; and
a selection section configured to select a road along which the user is proceeding from among candidates for the road, based on an analysis result obtained by recognizing a character written on a signpost included in a video in which a view in a travelling direction of the user is shot.

2. The information processing apparatus according to claim 1,
wherein the selection section selects the road along which the user is proceeding based on an appearance pattern of a signpost including a special character in the analysis result.

3. The information processing apparatus according to claim 2,
wherein the selection section selects the road along which the user is proceeding based on presence or absence of appearance of the special character that is assumed to appear only on any one of the roads among the candidates for the road.

4. The information processing apparatus according to claim 1,
wherein the candidates for the road are a general road and an expressway, one of which runs above the other, and
wherein the selection section selects one of the general road and the expressway as the road along which the user is proceeding.

5. The information processing apparatus according to claim 4,
wherein the selection section selects the road along which the user is proceeding based on the analysis result, which is a result obtained by checking character information acquired from a storage device, which holds signpost information including position information of a signpost set up on the expressway and character information written on the signpost, against character information of the signpost included in the video.

6. The information processing apparatus according to claim 5, further comprising
an updating section configured to update the signpost information included in the storage device based on the result obtained by checking the character information acquired from the storage device holding the signpost information against the character information of the signpost included in the video.

7. The information processing apparatus according to claim 6,
wherein, when the checking result indicates that a part of the character information acquired from the storage device holding the signpost information does not correspond with a part of the character information of the signpost included in the video, the updating section updates the non-corresponding part of the signpost information included in the storage device.

8. The information processing apparatus according to claim 1, further comprising:
a destination setting section configured to set a destination in accordance with input from the user; and
a route guidance section configured to show a route to the destination using position information of the user based on the road selected by the selection section.

9. An information processing method comprising:
a measurement step of measuring a position of a user;
an extraction step of extracting a candidate for a road along which the user is proceeding based on the result of the position measurement;
an analysis step of recognizing a character written on a signpost included in a video in which a view in a travelling direction of the user is shot; and
a selection step of selecting a road along which the user is proceeding from among candidates for the road, based on the analysis result obtained in the analysis step.

10. An information processing system comprising:
an imaging device configured to shoot a view in a travelling direction of a user; and
an information processing apparatus which includes a map matching section configured to extract, based on a result obtained by measuring a position of the user, a candidate for a road along which the user is proceeding, and a selection section configured to select a road along which the user is proceeding from among candidates for the road, based on an analysis result obtained by recognizing a character written on a signpost included in a video shot by the imaging device.

11. A program for causing a computer to function as an information processing apparatus which includes
a map matching section configured to extract, based on a result obtained by measuring a position of a user, a candidate for a road along which the user is proceeding, and
a selection section configured to select a road along which the user is proceeding from among candidates for the road, based on an analysis result obtained by recognizing a character written on a signpost included in a video in which a view in a travelling direction of the user is shot.
